(19) United States
(12) Patent Application Publication
(10) Pub. No.: US 2018/0226659 A1
(43) Pub. Date: Aug. 9, 2018

(54) FUEL CELL WITH THERMAL ENERGY STORAGE FOR FLEXIBILITY IN HYBRIDS

(71) Applicant: United States Department of Energy, Washington, DC (US)

(72) Inventors: Dave Tucker, Core, WV (US); Larry Shadle, Morgantown, WV (US); Paul Jablonski, Salem, OR (US); Nor Farida Harun, Morgantown, WV (US); David Berry, Mount Morris, PA (US)

(21) Appl. No.: 15/881,673

(22) Filed: Jan. 26, 2018

Related U.S. Application Data
(60) Provisional application No. 62/450,863, filed on Jan. 26, 2017.
(60) Provisional application No. 62/564,629, filed on Sep. 28, 2017.

(51) Int. Cl. H01M 8/021; H01M 8/04089; H01M 8/04701; H01M 8/04746; H01M 8/04791; H01M 8/1246

(52) U.S. Cl. CPC H01M 8/021; H01M 8/04089; H01M 8/04708; H01M 2008/1293; H01M 8/04798; H01M 8/1246; H01M 8/04753

(57) ABSTRACT

Materials, methods of preparing, and methods of use relating to increasing heat capacity of a solid oxide fuel cell. In at least one embodiment, the solid oxide fuel cell includes a cathode side; an anode side; and an interconnect material. The method includes increasing heat capacity of the interconnect material by modifying the interconnect material composition to increase specific heat and/or the heat associated with a solid-solid phase transition; and increasing the interconnect geometry (mass and volume) in the solid oxide fuel cell.

### CROSS-REFERENCE TO RELATED APPLICATIONS

This application claims the benefit of and priority from U.S. Provisional Application No. 62/450,863 filed Jan. 26, 2017 and U.S. Provisional Application No. 62/564,629 filed Sep. 28, 2017 each of which is incorporated herein by reference in its entirety.

### STATEMENT OF GOVERNMENT SUPPORT

The United States Government has rights in this invention pursuant to an employer/employee and contractual relationships between the inventors and the U.S. Department of Energy, operators of the National Energy Technology Laboratory (NETL).

### FIELD OF THE INVENTION

One or more embodiments consistent with the present disclosure relate to fuel cell hybrid power systems to increase flexibility of solid oxide fuel cells systems and includes materials, methods of their preparation, and methods for use in various applications. More specifically, one or more embodiments relate to increasing flexibility in fuel cell turbine hybrids through the incorporation of thermal energy storage in fuel cells so that load following with minimal impact may be achieved.

### BACKGROUND

Known fuel cell hybrid power systems and standalone fuel cells systems suffer from loss. Airflow is used on the cathode for thermal management, but this may result in a significant decrease in total system parasitic losses. Further, known fuel cell hybrid power systems and standalone fuel cells systems suffer from ohmic losses, reducing system efficiency.

One or more advantages of embodiments of the present invention relate to materials, methods of preparing, and methods of use relating to increasing heat capacity of the solid oxide fuel cell. More specifically, one or more advantages of embodiments relate to increasing flexibility in fuel cell turbine hybrids through the incorporation of thermal energy storage in fuel cells so that load following with minimal impact may be achieved.

### SUMMARY

Embodiments relate to an apparatus, materials, methods to prepare, and methods of use relating to increasing heat capacity of the solid oxide fuel cell. In at least one embodiment, the solid oxide fuel cell includes a cathode side; an anode side; and an interconnect material. The method of use includes increasing heat capacity of the interconnect material by modifying the interconnected material composition to increase specific heat and/or the heat associated with a solid-solid phase transition; and increasing the interconnect geometry (mass and volume) in the solid oxide fuel cell.

The method of use includes the solid oxide fuel cell having a support in contact with the interconnect material and a catalyst coating in contract with the support; where the interconnect material comprises an anode, a cathode and an electrolyte there between.

Embodiments relate to a solid oxide fuel cell having increased heat capacity including a cathode side; an anode side; and an interconnect material.

Embodiments relate to a solid oxide fuel cell having increased heat capacity including a cathode side; an opposing anode side; an interconnect material proximate the cathode side; a support in contact with the interconnect material; and a catalyst coating in contact with the support.

One or more embodiments include a fuel feed proximate the anode side and an oxidant feed proximate the cathode side. One or more embodiments may include the interconnect material comprises an anode, a cathode and an electrolyte there between. The solid oxide fuel cell may include a power conditioner coupled to the interconnect material, specifically the where the power conditioner is coupled to the anode and cathode.

One or more embodiments relate to achieving greater stored thermal energy/thermal capacitance in fuel cells used in fuel cell turbine hybrids for example. One or more embodiments increase stored thermal energy or thermal capacitance in fuel cells by increasing interconnect mass; increasing interconnect specific heat and/or modifying the phase change in the interconnect material.

One or more embodiments relate to extracting and storing thermal energy in the fuel cell used in fuel cell turbine hybrids for example. One or more embodiments relate to extracting and storing thermal energy by modulating cathode airflow and/or modulating the methane content in the anode fuel flow.

Still one or more embodiments relate to reforming-based thermal energy extraction or storage, where the temperature gradient along the fuel cell may be managed by using a solid concentration gradient of the reforming catalyst on a support.

One or more embodiments relates to a method for increasing thermal energy storage of a solid oxide fuel cell. In this method the solid oxide fuel cell includes a cathode side; an anode side; and an interconnect material. The method includes modifying at least one of stored thermal energy/capacitance, extracting and storing thermal energy, and fuel cell temperature gradients.

Still another embodiment relates to a method for increasing thermal energy storage of a solid oxide fuel cell. The solid oxide fuel cell includes a cathode side; an anode side; an interconnect material. The method includes modifying at least stored thermal energy/capacitance.

One or more embodiments of the method includes modifying the stored thermal energy/capacitance includes increasing at least one of an interconnected mass of the solid oxide fuel cell, increasing an interconnected specific heat and modifying the phase change in the interconnect material.

One or more other embodiments of the method relates to extracting and storing thermal energy includes increasing at least one of a cathode airflow and methane content in a fuel flow in an anode in the interconnect material.

Still other embodiments of the method relate to modifying the fuel cell temperature gradients includes increasing methane flow causing endothermic reforming converting thermal energy to chemical energy, thereby increasing available thermal energy for load following.

### BRIEF DESCRIPTION OF THE DRAWINGS

These and other features, aspects, and advantages of the multiple embodiments of the present invention will become better understood with reference to the following description, appended claims, and accompanied drawings where:

FIG. 1 depicts a solid oxide fuel cell illustrating the process chemistry, input and output streams, and highlighting the interconnect material;

FIG. 2 depicts a graph illustrating the thermal properties of stainless steel (SS-441) commonly employed in solid oxide fuel cells;

FIG. 3 depicts a graph illustrating results of a dynamic, 1-dimensional, numerical model of a solid oxide fuel cell portraying the impact of a change in fuel composition on the temperature distribution along the length of the fuel cell;

FIG. 4 depicts a graph illustrating dynamic change in the heat extracted from the fuel cell after a change in fuel composition as calculated from a dynamic, 1-dimensional, numerical model of a solid oxide fuel cell;

FIG. 5 depicts a graph illustrating solid oxide fuel cell temperature profiling along its length for different sizes of interconnect both smaller and larger than the nominal interconnect mass as calculated from a dynamic, 1-dimensional, numerical model of a solid oxide fuel cell;

FIG. 6 depicts a graph illustrating the effect of the physical size of interconnect on steady state cathode air flow, heat extracted (Q), fuel cell voltage, and fuel cell efficiency as calculated from the parametric study using the dynamic, 1-dimensional, numerical model of a solid oxide fuel cell; and

FIG. 7 depicts another embodiment of a solid oxide fuel cell depicting the process chemistry, input and output streams, and highlighting the interconnect material.

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide materials, methods to prepare, and methods of use relating to increasing heat capacity of the solid oxide fuel cell (SOFC).

One or more embodiments provide increased flexibility in fuel cell hybrid power systems and increase efficiency in standalone fuel cells systems. By incorporating thermal energy storage in solid oxide fuel cell design, a significant amount of energy could be recovered without damage to the fuel cells. Also, by increasing the thermal mass of the fuel cell, less airflow would be required on the cathode for thermal management, resulting in a significant decrease in total system parasitic losses in a standalone fuel cell. Because the thermal energy storage will be implemented through an increase in size of the interconnect system, the ohmic losses would also decrease, resulting in higher cell voltage and system efficiency.

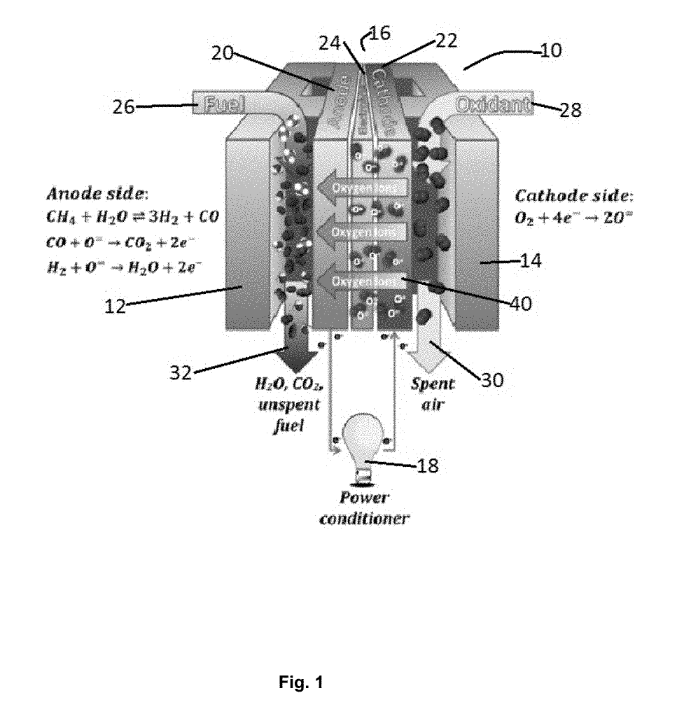

One or more embodiments of invention increase the heat capacity of the interconnect material in the SOFC by modifying the material composition to increase the specific heat and/or the heat associated with the solid-solid phase transition, and increasing the interconnect geometry (mass and volume) in the fuel cell, as illustrated in FIG. 1. Utilizing one or more embodiments, the amount of heat stored in the fuel cell 10 may be increased such that energy can be extracted and converted to electricity via a gas turbine, among other devices, without significantly changing the fuel cell temperature.

The fuel cell 10 illustrated in FIG. 1 includes an anode side 12, a cathode side 14, an interconnected material 16 positioned between the anode side 12 and cathode side 14 and power conditioner 18 connected to the interconnected material 16.

In at least one embodiment illustrated in FIG. 1 the fuel cell 10 includes an anode 20, a cathode 22 and an electrolyte 24 between the anode 20 and the cathode 22. As illustrated, the fuel cell 10 further includes a fuel feed 26 proximate the anode side 12 and an oxidant feed 28 proximate the cathode side 14. One or more embodiments of the illustrated fuel cell 10 increases the heat capacity of the interconnect material 16 by modifying the composition of the interconnect material 10 to increase specific heat and/or the heat associated with a solid-solid phase transition; and increases the interconnect geometry (mass and volume) in the solid oxide fuel cell 10.

In the illustrated embodiment, fuel is provided to the fuel cell 10 via the fuel feed 26 and oxidant is provided to the fuel cell 10 via the oxidant feed 28. Oxygen ions 40 flow across the incident material from the cathode to the anode. Spent air 30 is expelled from the fuel cell 10 proximate the cathode side 14 and H₂O, CO₂ and unspent fuel 32 is expelled from the fuel cell 10 proximate the anode side 12.

On the cathode side 14 the following occurs:

O2+4e⁻→2O⁼

On the anode side 12 the following occurs:

CH₄+H₂O↔3H₂+CO

CO+O⁼→CO₂+4e⁻

H₂+O⁼→H₂O+2e⁻

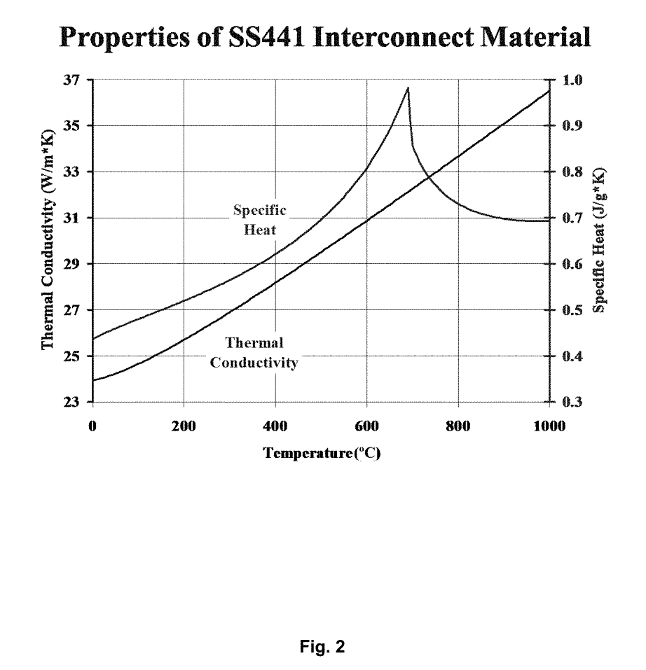

An example of the solid-solid phase transition is illustrated in FIG. 2. The transition from paramagnetic to ferromagnetic phases in steel requires a certain amount of heat, during which the solid temperature does not change. By modifying the SS-441 material, the temperature of the transition and the overall heat of phase change could be optimized by minute changes to the chemistry of the interconnect materials to enhance the thermal stability of the SOFC during extractions or injection of thermal energy.

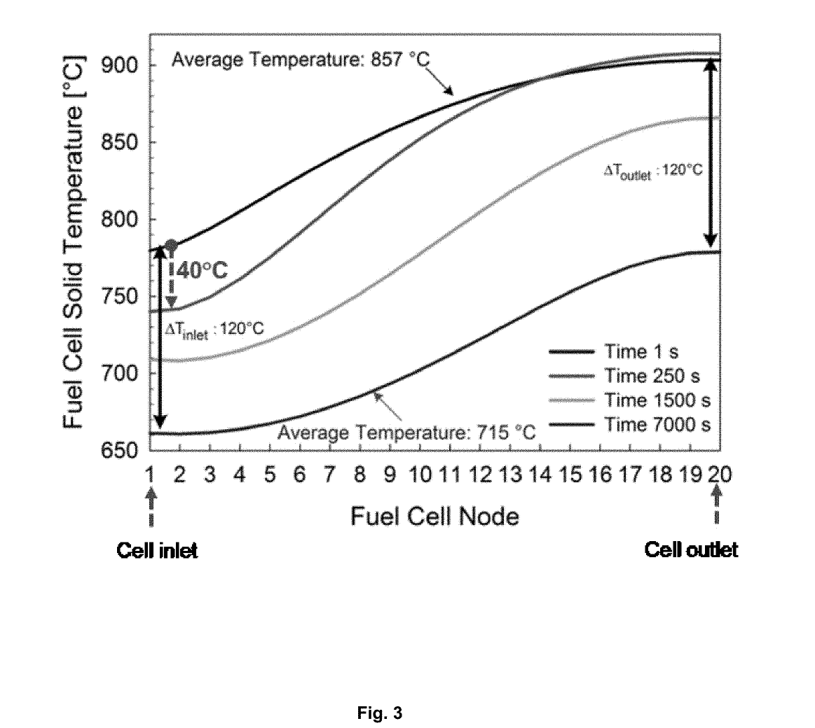

The temperature profile along a SOFC undergoing a transition in fuel composition is illustrated in FIG. 3. This was discovered by conducting a parametric study on a 1-dimensional, dynamic numerical model of a SOFC. As shown, the inlet temperature of the fuel cell is decreased by 40° C. in 250 seconds. This represents a significant increase in the thermal energy by extracted from the fuel cell and being moved to the gas turbine to be converted into electric power.

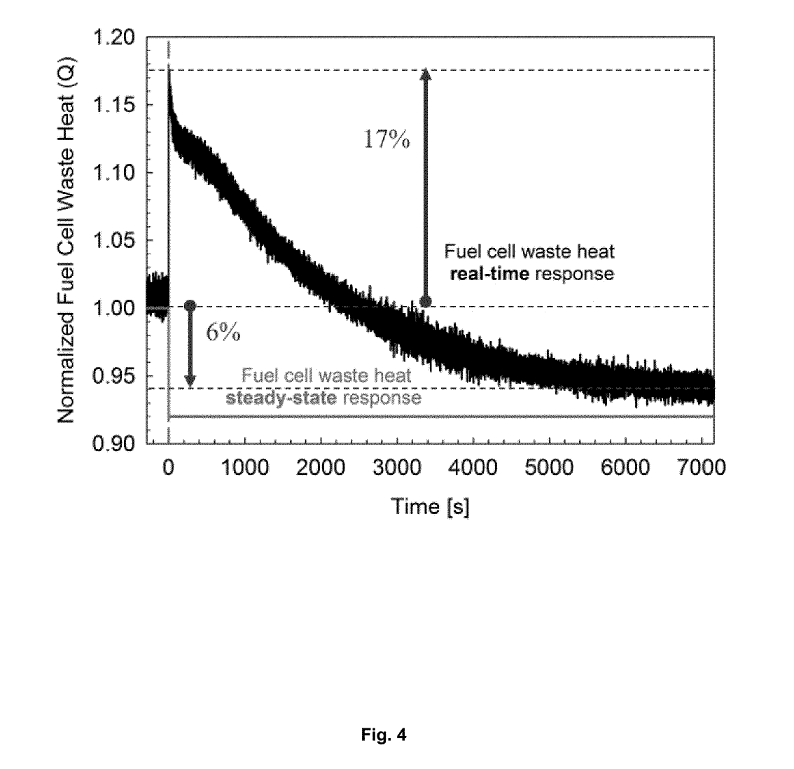

As illustrated in FIG. 4, an even more rapid extraction may be achieved by changing the composition of the fuel cell used to fire the fuel cell by simply increasing the methane content in the fuel supplied to the fuel cell, representing a total decrease in heating value of the fuel, for example 17% increase in thermal energy to the turbine can be realized in just 80 ms. This results in a very rapid increase in the turbine speed which is instantaneously converted to a proportional increase in the electric power generated.

If the baseline fuel includes a nominal amount of species that can be reformed, such as methane, then thermal energy can be stored just as quickly by reducing the amount of the reformable species. When this is accompanied by an appropriate load transient condition (i.e., a sudden reduction of electric load demand).

Existing thermal energy storage does not directly generate electricity, and extraction of energy is only considered by modulating the mass flow of the working fluid. In at least one embodiment the thermal energy storage is integral to the power generation.

Existing fuel cells minimize interconnect materials. Here the materials are engineered or optimized to include thermal energy storage.

Thermal energy in this system could be extracted in milliseconds without modulation of the working fluid. Using both, it would be possible to deal with large deviations in load demand, thereby stabilizing the electric grid.

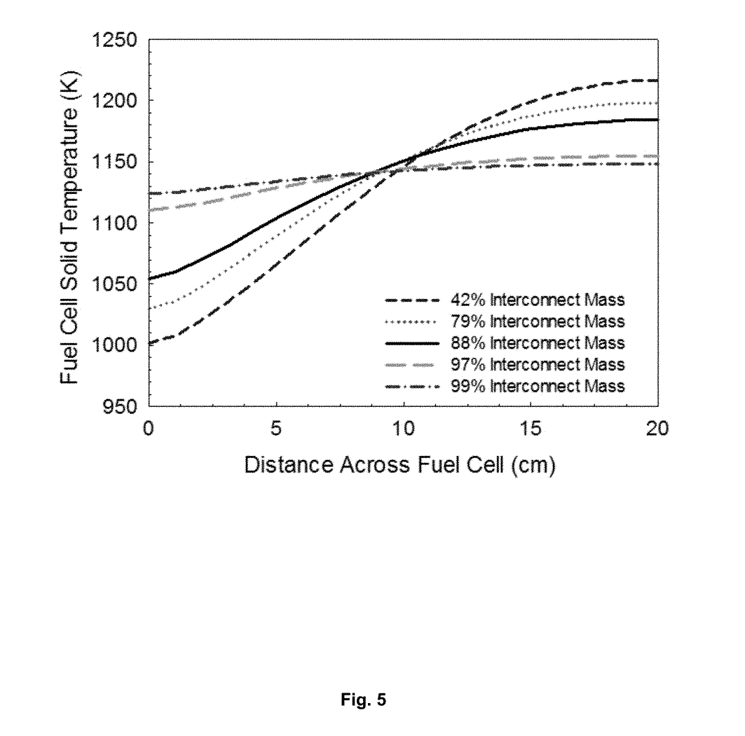

Thermal stress in the fuel cell would be reduced, as shown by the temperature profile in FIG. 5, making the fuel cell more robust to load transients and thermal shock. One or more embodiments relate to extracting and storing thermal energy by modulating cathode airflow. This may be accomplished if the interconnect mass is increased as shown in FIG. 5. With the smallest mass, the temperature gradient is at the limit for the material. This temperature gradient is limited during transient operation only by the cathode airflow used to cool the fuel cell. In at least one embodiment, the increased interconnect mass provides much lower temperature gradients so that cathode airflow may be used to store or extract thermal energy so that the turbine can load follow;

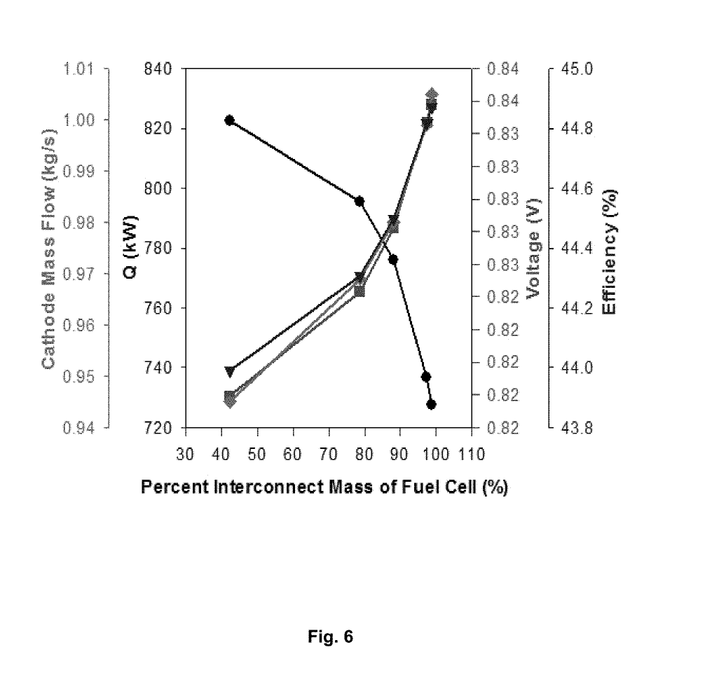

The additional interconnect mass also reduces polarizations in the fuel cell, increasing voltage and consequently, fuel cell efficiency as shown in FIG. 6.

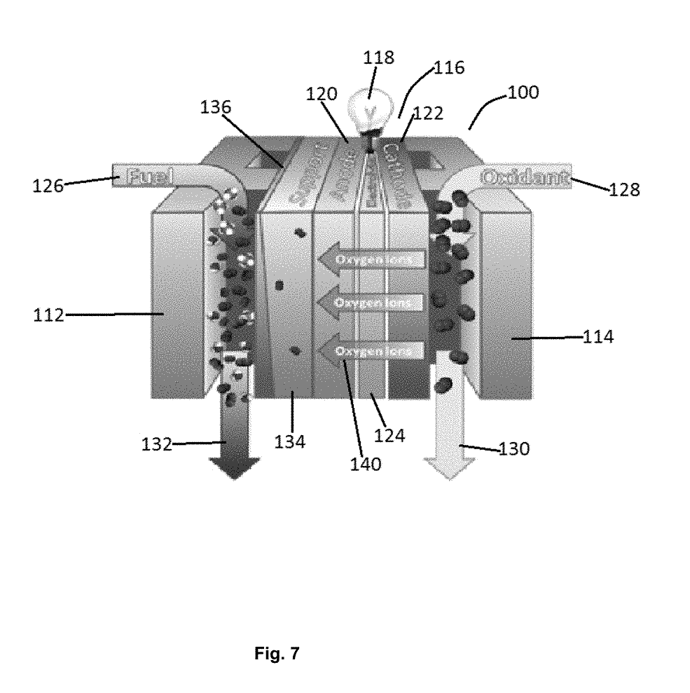

FIG. 7 depicts another embodiment of a solid oxide fuel cell 100 depicting the process chemistry, input and output streams, and highlighting the interconnect material. Embodiments of invention include Carbon & Sulfur tolerant fuel reforming catalyst and/or H₂/H₂O membrane. Utilizing one or more embodiments, the amount of heat stored in the fuel cell 100 may be increased such that energy can be extracted and converted to electricity via a gas turbine, among other devices, without significantly changing the fuel cell temperature.

The fuel cell 100 illustrated in FIG. 7 includes an anode side 112, a cathode side 114, an interconnected material 116 positioned between the anode side 12 and cathode side 114, a support 134 in contact with the interconnect material 116, a catalyst coating 136 in contract with the support 134 and the anode side 112, and power conditioner 118 connected to the interconnected material 116.

In at least one embodiment illustrated in FIG. 7 the fuel cell 100 includes an anode 120, a cathode 122 and an electrolyte 124 between the anode 120 and the cathode 122. As illustrated, the fuel cell 100 further includes a fuel feed 126 proximate the anode side 112 and an oxidant feed 128 proximate the cathode side 114. One or more embodiments of the illustrated fuel cell 100 increases the heat capacity of the interconnect material 116 by modifying the composition of the interconnect material 100 to increase specific heat and/or the heat associated with a solid-solid phase transition; and increases the interconnect geometry (mass and volume) in the solid oxide fuel cell 100.

In the illustrated embodiment, fuel is provided to the fuel cell 100 via the fuel feed 126 and oxidant is provided to the fuel cell 100 via the oxidant feed 128. Oxygen ions flow across the incident material from the cathode to the anode. Spent air 130 is expelled from the fuel cell 100 proximate the cathode side 114 and H₂O, CO₂ and unspent fuel 132 is expelled from the fuel cell 100 proximate the anode side 112.

On the cathode side 14 the following occurs:

O2+4e⁻→2O⁼

On the anode side 12 the following occurs:

CH₄+H₂O↔3H₂+CO

CO+O⁼→CO₂+4e⁻

H₂+O⁼→H₂O+2e⁻

Carbon & Sulfur Tolerant Fuel Reforming/Shift Catalyst (Pyrochlore for example) may be applied throughout the fuel passages to reform hydrocarbon fuels into a predominant H₂-rich fuel and provide water-gas shift function to convert reform product CO into CO₂ and additional H₂ (upon reaction of the CO with H₂O). These catalysts may be applied throughout the fuel channel to the Membrane/Support Surfaces; to the Interconnect Surfaces; inserted on separate porous support into the channel or combination thereof.

Catalyst could be applied in either uniform or graded fashion to control reforming along the anode. Embodiments of the invention would accommodate large variations in hydrocarbon partial pressure and provide for control of thermal gradients (through reforming exo-endo therms) from inlet to outlet of the fuel cell; catalyst coated surfaces of any metal-containing components in the fuel passage would reduce undesired reaction with sulfur or carbon and increase life of the fuel cell; and would also convert organic sulfur compounds into H2S to allow for easier removal/cleanup.

Embodiments using this type of membrane isolate the incoming fuel from the anode, allowing only H₂/H₂O to pass back and forth between the separated areas. Embodiments would increase performance (efficiency/output) by maximize H₂ (higher Nernst potential) and minimizing diluents (CO₂, N₂) and contaminants at the anode. One or more embodiments reduce degradation from fuel composition effects of hydrocarbons and CO as they would be reformed/shifted at the surface (by the reforming/shift catalyst above) into H₂-rich gas and only allow the H₂/H₂O to pass to/from the anode, thereby isolating anode from the undesired gas component effects. (See Harun, N. F., Zaccaria, V., Tucker, D., Traverso, A., and Adams, T. A. II, Degradation Analysis of SOFC for Various Syngas Compositions in IGFC Systems, International Gas Turbine Congress 2015, Tokyo, Japan, November 2015 incorporated herein by reference in its entirety). The physical isolation of the membrane would also provide opportunities limiting diffusion of sulfur and other contaminants to the anode, which would further limit degradation. Since the membrane would provide support, the anode layer may be optimized for H₂ and made thinner, which should optimize performance; reduce anode material costs; potentially increasing the inert mass for thermal energy storage.

This may be accomplished by coating the interconnect and support structure with a reforming catalyst (See FIG. 7). An increase in methane flow causes endothermic reforming, converting thermal energy to chemical energy, and then increasing the thermal energy available to the turbine for load following. A decrease in methane would result in more thermal energy being stored.

In a reforming-based thermal energy extraction or storage, the temperature gradient along the fuel cell may be managed by using a solid concentration gradient of the reforming catalyst on a support (See FIG. 7). In this case, fuel cell temperature gradients may be maintained shallow, even during the most extreme transients. This would further support load following.

It would be possible to incorporate thermal energy storage in turbine recuperators to realize the same flexibility. Natural gas could be routed through channels in the heat exchanger to extract thermal energy storage.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

We claim:

1. A solid oxide fuel cell having increased thermal energy storage comprising:
a cathode side;
an anode side; and
an interconnect material.

2. The solid oxide fuel cell of claim 1 further including a fuel feed proximate the anode side and an oxidant feed proximate the cathode side.

3. The solid oxide fuel cell of claim 1 wherein the interconnect material comprises an anode, a cathode and an electrolyte there between.

4. The solid oxide fuel cell of claim 3 further comprising a power conditioner coupled to the interconnect material.

5. The solid oxide fuel cell of claim 1 further including a support in contact with the interconnect material.

6. The solid oxide fuel cell of claim 5 further including a catalyst coating in contract with the support.

7. A method for increasing thermal energy storage of a solid oxide fuel cell, the solid oxide fuel cell comprising:
a cathode side;
an anode side; and
an interconnect material;
the method comprising modifying at least one of stored thermal energy/capacitance, extracting and storing thermal energy, and fuel cell temperature gradients.

8. The method of claim 7 wherein modifying the stored thermal energy/capacitance comprises increasing at least one of an interconnected mass of the solid oxide fuel cell, increasing an interconnected specific heat and modifying the phase change in the interconnect material.

9. The method of claim 7 wherein modifying the extracting and storing thermal energy comprises increasing at least one of a cathode airflow and methane content in a fuel flow in an anode in the interconnect material.

10. The method of claim 7 wherein modifying the fuel cell temperature gradients comprises increasing methane flow causing endothermic reforming converting thermal energy to chemical energy, thereby increasing available thermal energy for load following.

11. The method of claim 7 wherein modifying the fuel cell temperature gradients comprises decreasing methane flow causing storing thermal energy.

12. A method for increasing thermal energy storage of a solid oxide fuel cell, the solid oxide fuel cell comprising:
a cathode side;
an anode side; and
an interconnect material;
the method comprising modifying at least stored thermal energy/capacitance.

13. The method of claim 12 wherein modifying the stored thermal energy/capacitance comprises increasing an interconnected mass of the solid oxide fuel cell.

14. The method of claim 12 wherein modifying the stored thermal energy/capacitance comprises increasing an interconnected specific heat extracting and storing thermal energy.

15. The method of claim 12 wherein modifying the stored thermal energy/capacitance comprises modifying the phase change in the interconnect material.

16. The method of claim 12 further comprising modifying an extraction and storage of thermal energy.

17. The method of claim 16 wherein modifying the extraction and storage of thermal energy comprises increasing modulating cathode airflow.

18. The method of claim 16 wherein modifying the extraction and storage of thermal energy comprises increasing methane content in a fuel flow.

19. The method of claim 16 further comprising modifying fuel cell temperature gradients.

20. The method of claim 19 wherein modifying the fuel cell temperature gradients comprises increasing methane flow causing endothermic reforming converting thermal energy to chemical energy, thereby increasing available thermal energy for load following or decreasing methane flow causing storing thermal energy.
